(19) United States
(12) Patent Application Publication
(10) Pub. No.: US 2003/0236684 A1
(43) Pub. Date: Dec. 25, 2003

(54) Insurance surcharge for athletes

(76) Inventor: Angel Luis Rodriguez, Orlando, FL (US)

Correspondence Address: ANGEL LUIS RODRIGUEZ, 3941 AMRON COURT, ORLANDO, FL, 32822, US

(21) Appl. No.: 10/151,345

(22) Filed: Jun. 25, 2002

(51) Int. Cl. G06F 17/60

(52) U.S. Cl. 705/4

(57) ABSTRACT

My invention adds the new dimension of providing a mechanism whereby life insurance, health insurance, accident insurance, and pension benefits can be funded for the purpose of making these aforementioned insurances and benefits individually or universally available on a full time basis to professional or amateur athletes. Especially those athletes in sports that currently do not have any or parts of the aforementioned benefits. For example, professional boxers who don't have twenty four hour health, accident, or life insurance protection nor pension benefits, can now enjoy parts of all of these benefits if entities get involved to facilitate the means by which to fund the premiums or contributions for the insurances and/or benefits.

### DETAILED DESCRIPTION OF THE INVENTION

I, Angel Rodriguez, am officially and formally placing a patent on the following ideas, methods, mechanisms, and actions for funding health insurance, life insurance, accident insurance and pension benefits for current and former professional and amateur athletes. My patent includes the placement of surcharges on pay-per-view, beverages, merchandise, ticket, parking lot fees, commercial, closed-circuit sales as well as ancillary and alternative sources of revenue or income for the purpose of paying life insurance, health insurance, accident insurance, and pension benefits on current and former professional or amateur athletes. This patent encapsulates the funding of life insurance, health insurance, accident insurance, or pension benefits for temporary or long periods of coverage. This patent covers any promoter(s), manger(s), state commission(s), sports' officials, title sanctioning bodies, private or public individual(s), charities, affiliated or non-affiliated and interested or non-interested corporation(s), cable companies, athletes, participant(s), media outlet(s) (which use each, any, and all means of broadcast be it televised, printed, radio, or internet) or any other entity that incorporates any facet, part, or entire sum of the idea, promotion, or practice of raising or receiving donated funds (as well as ancillary or alternative sources or income and revenue) for the purpose of paying life insurance, health insurance, accident insurance, and pension benefits premiums and contributions for current and former professional athletes. The patent also includes any sort of matching contributions along with ancillary and alternative sources of revenue and income from any affiliated, non-affiliated, interested, and non-interested entities mentioned and not mentioned that finances life insurance, health insurance, accident insurance, or pension benefits of current and former professional or amateur athletes. Also covered by this patent is the act of placing non-for-profit and for profit charities as beneficiaries of an active or retired professional athlete's life insurance death benefits funded through these mechanisms. The sum total of the funds collected via these aforementioned methods, as well as ancillary and alternative sources of revenue and income, will be used specifically for the payment of the combatant's life insurance, health insurance, accident insurance, and pension benefits.

1. What I claim as my invention is the use of surcharges or any other fundraising or charitable contribution to fund the life insurance, health insurance, accident insurance, or pension benefits of retired or active professional and amateur athletes. This range covers pay-per-view, beverages, merchandise, ticket, parking lot fees, commercial, closed-circuit sales as well as ancillary and alternative sources of revenue or income raised by promoter(s), manger(s), state commission(s), sports' officials, title sanctioning bodies, private or public individual(s), charities, affiliated or non-affiliated and interested or non-interested corporation(s), cable companies, athletes, participant(s), media outlet(s) (which use each, any, and all means of broadcast be it televised, printed, radio, or internet) or any other entity that incorporates any facet, part, or entire sum of the idea, promotion, or practice of raising or receiving donated funds (as well as ancillary or alternative sources or income and revenue).
